(19) United States
(12) Patent Application Publication
(10) Pub. No.: US 2011/0026981 A1
(43) Pub. Date: Feb. 3, 2011

(54) IMAGE FORMING APPARATUS FOR OBTAINING MULTIPLE IMAGE BY ADJUSTING PLURAL IMAGES

(75) Inventor: Tetsuro Sakai, Saitama (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/841,351

(22) Filed: Jul. 22, 2010

Related U.S. Application Data
(60) Provisional application No. 61/229,101, filed on Jul. 28, 2009.

(51) Int. Cl. G03G 15/01

(52) U.S. Cl. 399/301

(57) ABSTRACT

An image forming apparatus includes a running member including an image formation area, plural image forming sections to form a density adjustment pattern respectively on a straight line perpendicular to a running direction of the running member at a time of density adjustment, plural density detection sections to simultaneously detect the density adjustment patterns on the straight line respectively and simultaneously, and a density correction section to correct image densities of the plural image forming sections respectively based on detection results of the density adjustment patterns obtained by the plural density detection sections.

### CROSS-REFERENCE TO RELATED APPLICATION

This application is based upon and claims the benefit of priority from Provisional U.S. Application 61/229,101 filed on Jul. 28, 2009, the entire contents of which are incorporated herein by reference.

### FIELD

Embodiments described herein relate generally to an image forming apparatus for obtaining a multiple image by superimposing plural images formed by plural image forming sections in a copying machine or a multi-function peripheral including plural image forming sections.

### BACKGROUND

In an image forming apparatus for obtaining a color image by superimposing plural images, image quality is maintained by performing registration adjustment to adjust the positional relation between plural images and by adjusting the density between the plural images. On the other hand, in the image forming apparatus, when the time of adjustment to maintain the image quality at, for example, the time of warming-up of the image forming apparatus becomes long, there is a fear that the waiting time of the user until the image adjustment is ended becomes long.

Thus, the development of an image forming apparatus is desired in which adjustment to maintain image quality is certainly performed to obtain high image quality, and further, the time of the adjustment to maintain the image quality is shortened to shorten the waiting time of the user, and the image forming speed is increased.

### DESCRIPTION OF THE DRAWINGS

FIG. 1 is a schematic structural view showing a color copying machine of a first embodiment;

FIG. 2 is a block diagram showing a control system of the first embodiment;

FIG. 3 is a schematic perspective view showing a part of a transfer belt of the first embodiment:

FIG. 4 is a schematic explanatory view showing a part of the transfer belt of the first embodiment;

FIG. 5 is a flowchart showing registration adjustment of the first embodiment;

FIG. 6 is a schematic explanatory view showing patterns printed on the transfer belt of the first embodiment;

FIG. 7 is an explanatory view for explaining the setting of an adjustment value of image inclination from the patterns of the first embodiment;

FIG. 8 is an explanatory view showing an inclination shift on a photoconductive drum of the first embodiment;

FIG. 9 is an explanatory view showing a toner image resulting from the inclination shift of the first embodiment;

FIG. 10 is an explanatory view showing an adjustment of a tilt mirror of the first embodiment;

FIG. 11 is an explanatory view for explaining the setting of an adjustment value of a writing start timing shift in a sub-scanning direction from the patterns of the first embodiment;

FIG. 12 is an explanatory view showing the writing start timing shift in the sub-scanning direction on a photoconductive drum of the first embodiment;

FIG. 13 is an explanatory view showing a toner image resulting from the writing start timing shift in the sub-scanning direction of the first embodiment;

FIG. 14 is an explanatory view for explaining the setting of an adjustment value of a writing start timing shift in a main scanning direction from the patterns of the first embodiment;

FIG. 15 is an explanatory view showing the writing start timing shift in the main scanning direction on the photoconductive drum of the first embodiment;

FIG. 16 is an explanatory view showing a toner image resulting from the writing start timing shift in the main scanning direction of the first embodiment;

FIG. 17 is an explanatory view for explaining the setting of an adjustment value of a main scanning magnification shift from the patterns of the first embodiment;

FIG. 18 is an explanatory view showing the main scanning magnification shift on the photoconductive drum of the first embodiment;

FIG. 19 is an explanatory view showing a toner image resulting from the main scanning magnification shift of the first embodiment;

FIG. 20 is a flowchart showing a density adjustment of the first embodiment;

FIG. 21 is an explanatory view showing patches for density detection of the first embodiment;

FIG. 22 is an explanatory view showing the relation between an image density and a detection value of a density sensor of the first embodiment;

FIG. 23 is a schematic perspective view showing a part of a transfer belt of a second embodiment;

FIG. 24 is a schematic explanatory view showing a part of the transfer belt of the second embodiment; and

FIG. 25 is an explanatory view showing a main scanning magnification shift on a photoconductive drum of the second embodiment.

### DETAILED DESCRIPTION

According to an embodiment, An image forming apparatus comprising: a running member including an image formation area; a plurality of image forming sections to form a density adjustment pattern respectively on a straight line perpendicular to a running direction of the running member at a time of density adjustment; a plurality of density detection sections to detect the density adjustment patterns on the straight line respectively and simultaneously; and a density correction section to correct image densities of the plurality of image forming sections respectively based on detection results of the density adjustment patterns obtained by the plurality of density detection sections.

### First Embodiment

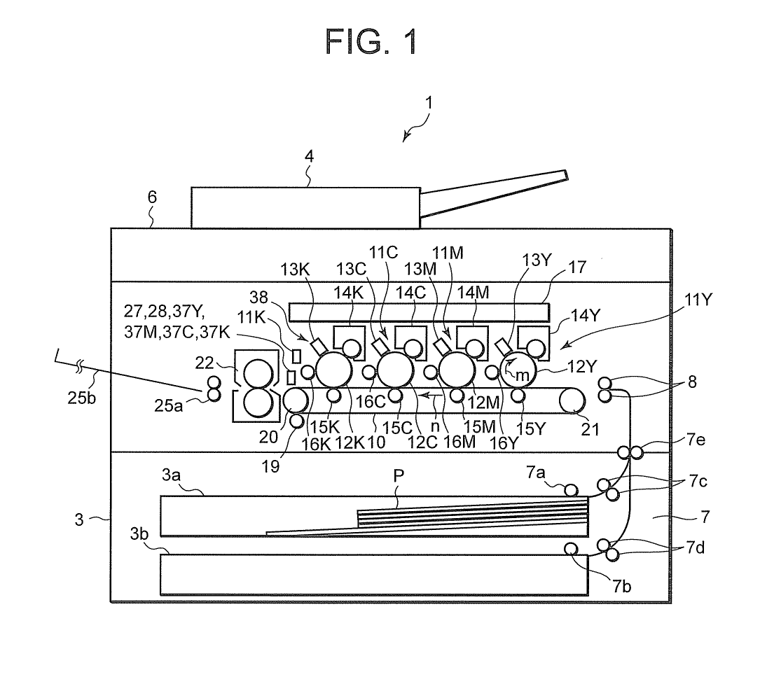

FIG. 1 is a schematic structural view of a color copying machine 1 of four-drum tandem system as an image forming apparatus of a first embodiment. The color copying machine 1 includes a scanner section 6 to read a document supplied by an auto document feeder 4. The color copying machine 1 includes, as image forming sections, four image forming stations 11Y, 11M, 11C and 11K of yellow (Y), magenta (M), cyan (C) and black (K) arranged in parallel along a transfer belt 10 as a running member.

The image forming stations 11Y, 11M, 11C and 11K respectively include photoconductive drums 12Y, 12M, 12C and 12K as image carriers. Rotation shafts of the photoconductive drums 12Y, 12M, 12C and 12K are parallel to a direction (main scanning direction) perpendicular to a running direction (sub-scanning direction) of an arrow n direction of the transfer belt 10. The respective rotation shafts of the photoconductive drums 12Y, 12M, 12C and 12K are spaced from each other at regular intervals along the sub-scanning direction.

Charging chargers 13Y, 13M, 13C and 13K, developing devices 14Y, 14M, 14C and 14K, and photoconductive cleaners 16Y, 16M, 16C and 16K are arranged respectively around respective photoconductive drums 12Y, 12M, 12C and 12K in a rotation direction of an arrow m direction. A laser exposure device 17 forms electrostatic latent images based on data of respective color components of image data on the photoconductive drums 12Y, 12M, 12C and 12K. The developing devices 14Y, 14M, 14C and 14K develop the electrostatic latent images of the respective color components on the photoconductive drums 12Y, 12M, 12C and 12K. The developing devices 14Y, 14M, 14C and 14K form toner images of yellow (Y), magenta (M), cyan (C) and black (K) on the respective photoconductive drums 12Y, 12M, 12C and 12K.

A drive roller 20 and a driven roller 21 support the transfer belt 10 and rotate in the arrow n direction. Each of transfer rollers 15Y, 15M, 15C and 15K as transfer sections transfers the toner images on the respective photoconductive drums 12Y, 12M, 12C and 12K to a sheet P conveyed by the transfer belt 10 in the arrow n direction respectively. During the transfer belt 10 running in the arrow n direction, the image forming stations 11Y, 11M, 11C and 11K superimpose the toner images onto the sheet P in an image formation area of the transfer belt 10 and form a color toner image.

A conveying unit 7 includes pickup rollers 7a and 7b to take out sheets from a cassette mechanism 3 having a first and a second paper feed cassettes 3a and 3b, separation conveyance rollers 7c and 7d, a conveyance roller 7e and a registration roller 8. A fixing device 22 fixes the color toner image on the sheet P. A paper discharge roller 25a discharges the sheet after completion of the fixing to a storage tray 25b. Photoconductive cleaners 16Y, 16M, 16C and 16K clean the toner remaining on the photoconductive drums 12Y, 12M, 12C and 12K respectively after completion of the transfer.

A first and a second registration sensors 27 and 28, as a shift detection section, are provided on both sides of the periphery of the transfer belt 10 at the downstream side of the image forming station 11K of black (K). Four toner adhesion amount sensors 37Y, 37M, 37C and 37K, as a density detection section, are provided at intermediate positions between the first and the second registration sensors 27 and 28. The first and the second registration sensors 27 and 28 detect shift adjustment patterns on the transfer belt 10, and the detection results are used for correction of an image shift between the respective image forming stations 11Y, 11M, 11C and 11K. The toner adhesion amount sensors 37Y, 37M, 37C and 37K detect density adjustment patterns on the transfer belt 10 for the respective color components, and the detection results are used for correction of image density of the respective image forming stations 11Y, 11M, 11C and 11K.

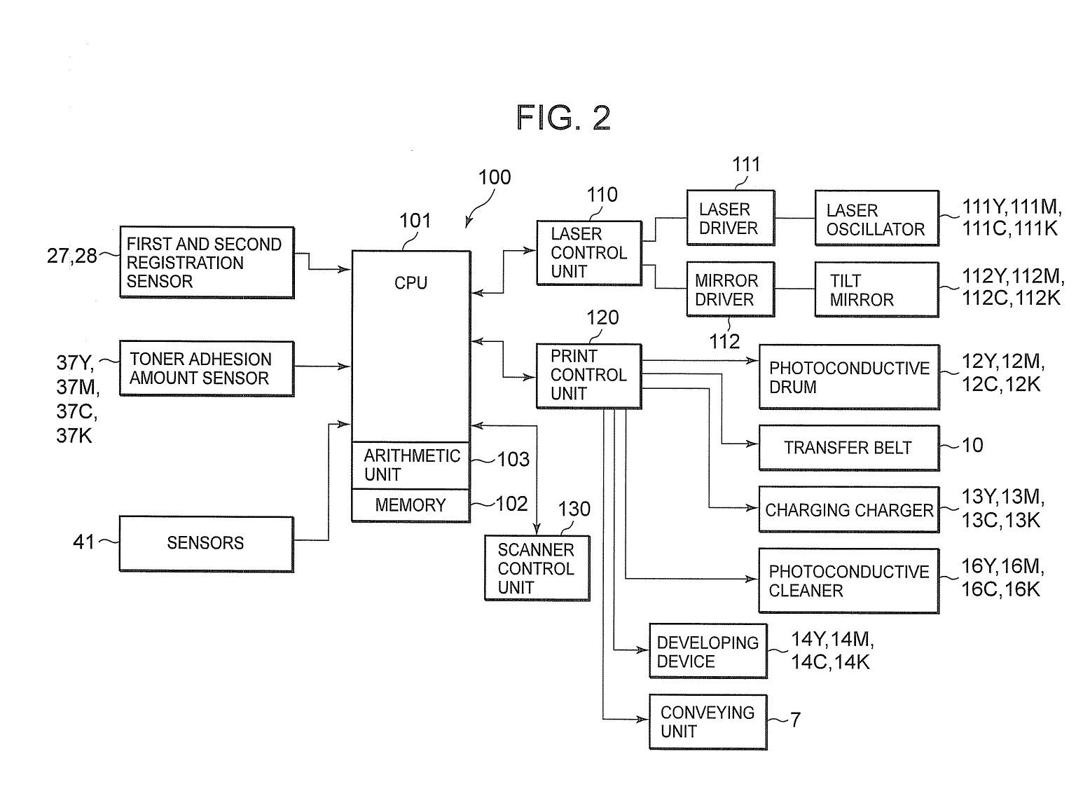

FIG. 2 is a block diagram of a control system 100 mainly showing the image adjustment of the color copying machine 1. The color copying machine 1 performs, as image adjustment, for example, image registration adjustment and image density adjustment. The first and the second registration sensors 27 and 28, and the toner adhesion amount sensors 37Y, 37M, 37C and 37K are connected to the input side of a CPU 101 to control the entire color copying machine 1. In addition, sensors 41 necessary for image formation are connected to the input side of the CPU 101.

The CPU 101 connects to a laser control unit 110 and a print control unit 120. The CPU 101 connects to a scanner control unit 130 to control the auto document feeder 4 and the scanner section 6.

The CPU 101 includes a memory 102 to store various settings for controlling the laser control unit 110 and the print control unit 120. The memory 102 stores, for example, a target range of image density.

The CPU 101 includes an arithmetic unit 103 to calculate an adjustment value for the registration adjustment and an adjustment value for the density adjustment by using the laser control unit 110 and the print control unit 120. In the registration adjustment, the adjustment value is calculated by using the detection results of the shift adjustment patterns printed on the transfer belt 10.

The laser control unit 110 adjusts the laser exposure device 17 based on the adjustment value obtained by calculation. In the density adjustment, the adjustment value is calculated by using the detection results of the density adjustment patterns printed on the transfer belt 10. The print control unit 120 adjusts the developing devices 14Y, 14M, 14C and 14K based on the adjustment value obtained by calculation. The CPU 101, the laser control unit 110 and the print control unit 120 constitute a density correction section.

The laser control unit 110 includes a laser driver 111 to adjust the writing start timings or the laser light amounts of the respective color components of laser oscillators 111Y, 111M, 111C and 111K of the respective color components in the laser exposure device 17. The laser control unit 110 includes a mirror driver 112 to adjust angles of tilt mirrors 112Y, 112M, 112C and 112K of the respective color components in the laser exposure device 17.

The print control unit 120 controls the photoconductive drums 12Y, 12M, 12C and 12K, the transfer belt 10, the charging chargers 13Y, 13M, 13C and 13K, the developing devices 14Y, 14M, 14C and 14K, the photoconductive cleaners 16Y, 16M, 16C and 16K, and the conveying unit 7. The print control unit 120 adjusts developing biases of the developing devices 14Y, 14M, 14C and 14K.

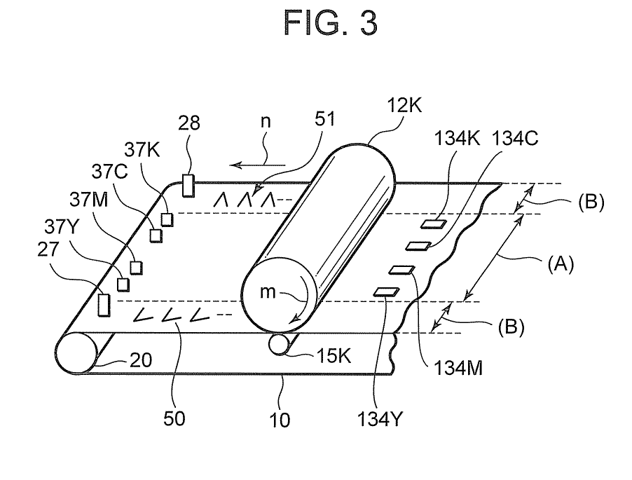

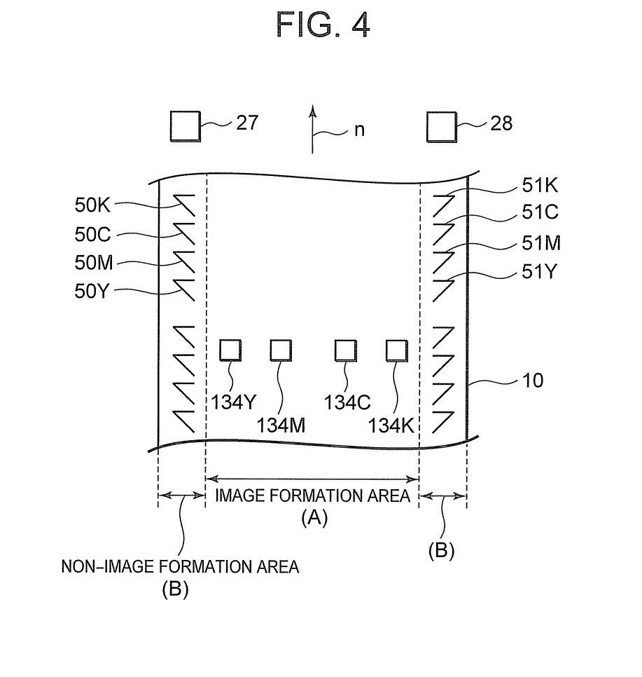

As shown in FIG. 3 and FIG. 4, the intermediate transfer belt 10 of the color copying machine 1 includes non-image formation areas (B) on both sides of an image formation area (A). The shift adjustment patterns for the image adjustment are printed in the non-image formation areas (B). The density adjustment pattern is printed in the image formation area (A).

At the time of the registration adjustment, the respective image forming stations 11Y, 11M, 11C and 11K print, for example, wedge-shaped patterns 50 and 51 in the non-image formation areas (B) of the transfer belt 10. The first registration sensor 27 measures the front side pattern 50, and the second registration sensor 28 measures the rear side pattern 51. The shape of the pattern is not limited.

At the time of the density adjustment, the respective image forming stations 11Y, 11M, 11C and 11K print, as density adjustment patterns, for example, patches 134Y, 134M, 134C and 134K of four colors of Y, M, C and K in the image formation area (A) of the transfer belt 10 so as to be arranged in the main scanning direction for the respective color components. The toner adhesion amount sensors 37Y, 37M, 37C and 37K respectively detect the patches 134Y, 134M, 134C and 134K of the four colors.

The color copying machine 1 to form a color image by superimposing toner images of the four colors of Y, M, C and K performs. The color copying machine 1 adjusts the registration adjustment to adjust the positions of the plural toner images and the density adjustment of the plural toner images as the image adjustment. In the color copying machine 1, the characteristic of the optical system of the laser exposure device 17 is changed by change of temperature in the machine. When the characteristic of the optical system is changed, a relative position shift occurs among the four color toner images. When the superimposition positions of the toner images of the four colors of Y, M, C and K shift, the color image blurs.

As elements of image position shifts between the plural image forming stations 11Y, 11M, 11C and 11K, there are, for example, an image inclination, an image writing start timing and a magnification error. In the image registration adjustment, the color copying machine 1 adjusts the image inclination, the image writing start timing, and the magnification error. It is preferable that the color copying machine 1 periodically performs the image registration adjustment.

In the color copying machine 1, a shift in the density of toner images of the four colors of Y, M, C and K occurs by the change of environmental characteristic in the machine, and the temporal characteristic change of the photoconductive drums 12Y, 12M, 12C and 12K. When the image densities of the four colors of Y, M, C and K shift, the balance of the colors is lost. It is preferable that the color copying machine 1 periodically performs the density adjustment on all of the four colors of Y, M, C and K.

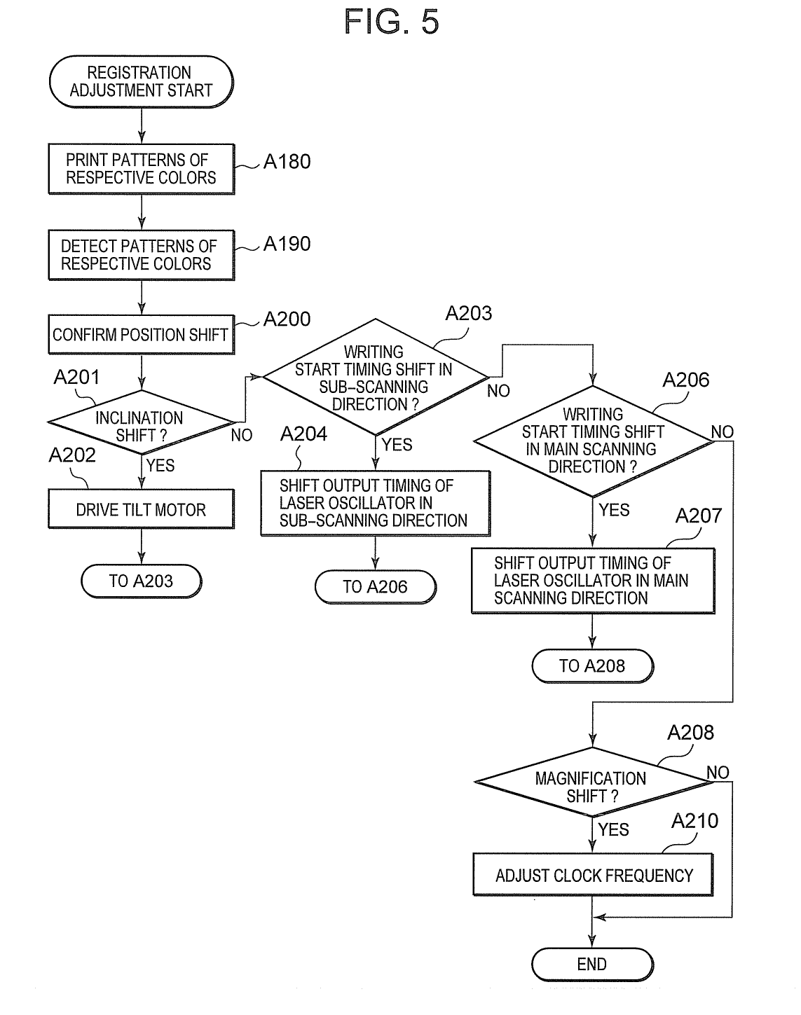

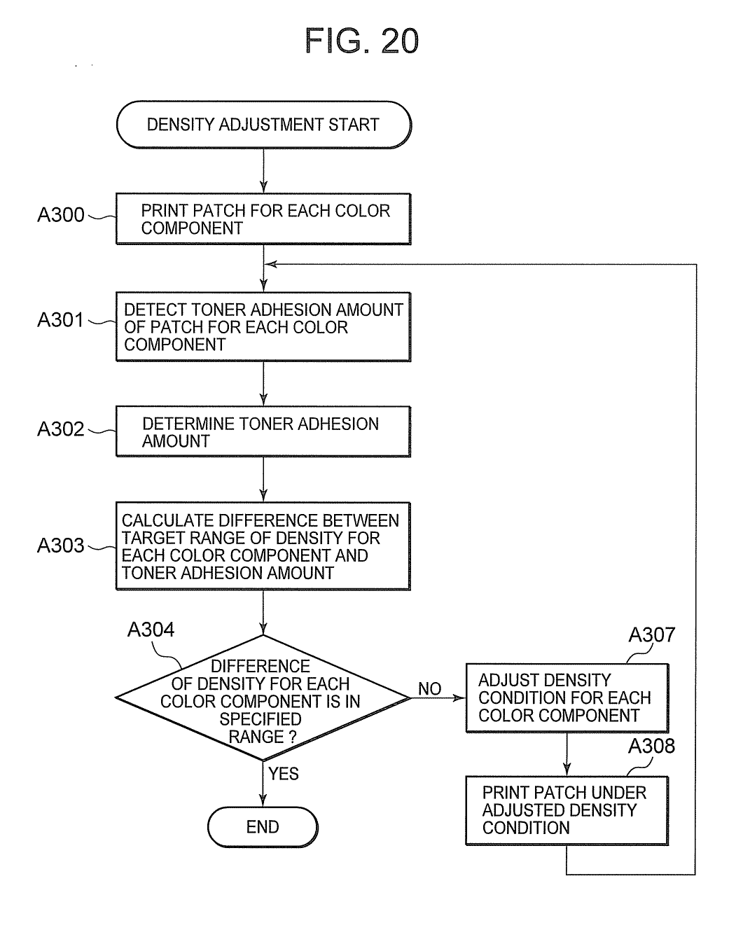

When a power source is turned ON, the color copying machine 1 starts warming up, and starts (I) image registration adjustment shown in FIG. 5 and (II) image density adjustment shown in FIG. 20.

(I) Image Registration Adjustment

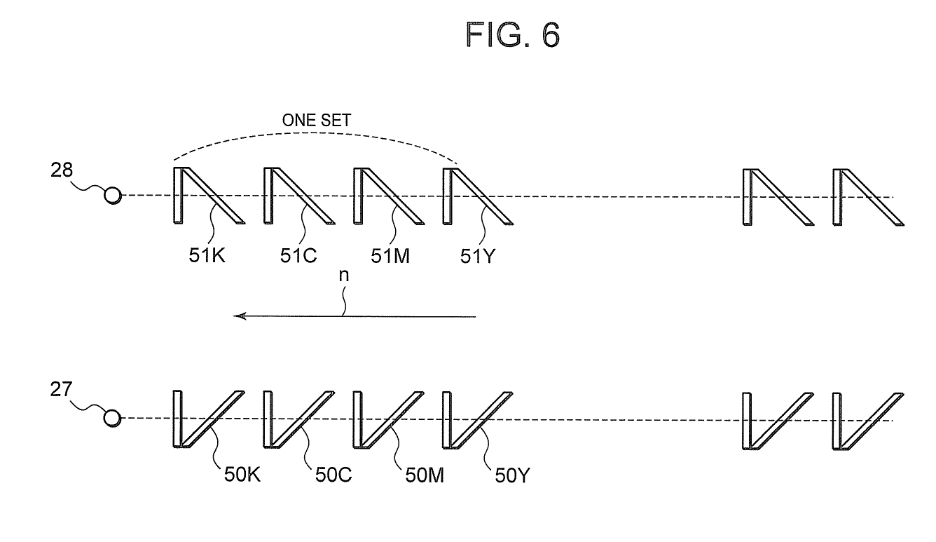

When the image registration adjustment is started, the image forming stations 11Y, 11M, 11C and 11K print wedge-shaped patterns 50 and 51 shown in FIG. 6, in which the four colors of Y, M, C and K constitute one set, on the transfer belt 10. A specified number of sets (hereinafter, an example of 8 sets is described), for example, 8 sets of wedge-shaped patterns are printed. The image forming stations 11Y, 11M, 11C and 11K print the 8 sets of front side patterns 50Y, 50M, 50C and 50K in the non-image formation area (B) on the front side of the transfer belt 10, and prints the 8 sets of rear side patterns 51Y, 51M, 51C and 51K in the non-image formation area (B) on the rear side of the transfer belt 10 (A180). The first and the second registration sensors 27 and 28 respectively measure the 8 sets of the patterns 50 and 51 in the non-image formation areas (B) (A190). The arithmetic unit 103 calculates an average value of the plural measured patterns, and the CPU 101 determines the image position shift (A200).

(a) Image Inclination Adjustment

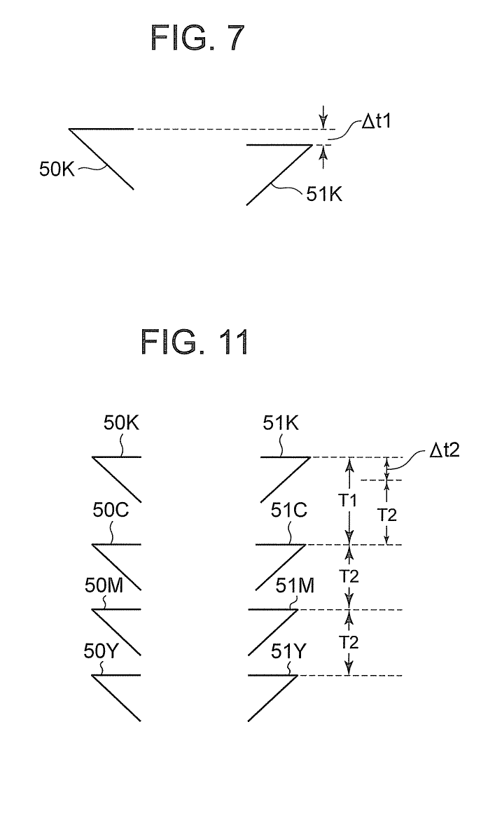

For example, as shown in FIG. 7, in the case that the output timing of the front side pattern 50K of black (K) and the output timing of the rear side pattern 51K are shifted from each other by Δt1 (Yes at A201).

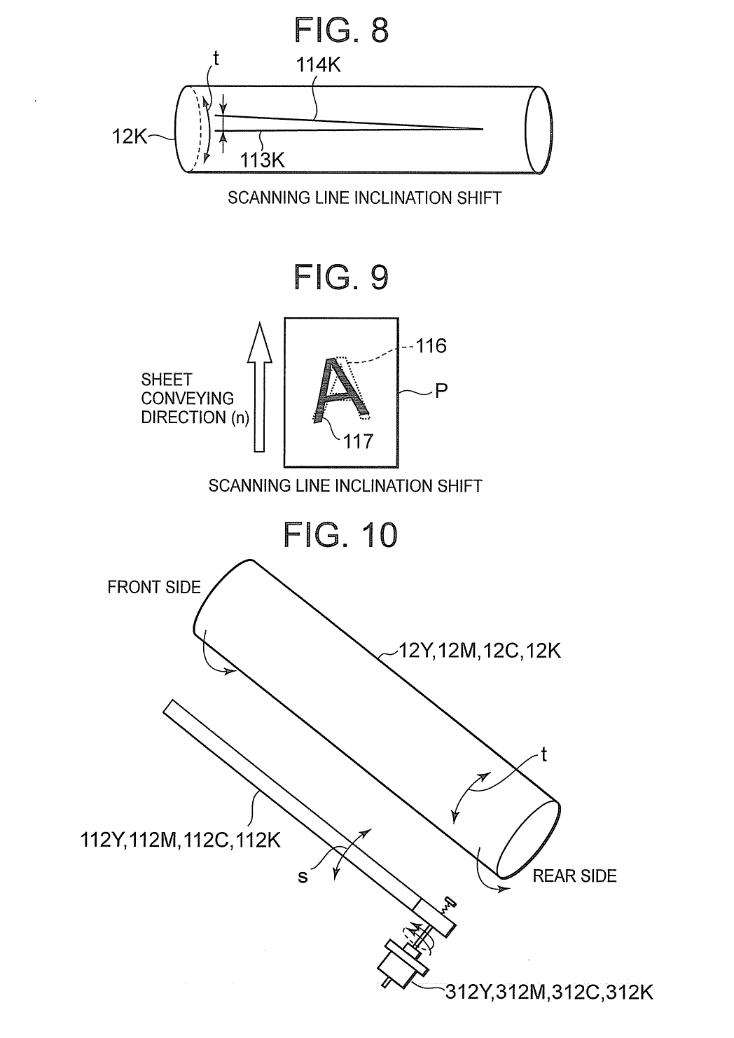

As shown in FIG. 8, the arithmetic unit 103 determines that a shaft 113K of the photoconductive drum 12K of black (K) is inclined with respect to a scanning direction 114K of a laser beam of the laser oscillator of black (K). When image formation is performed without adjustment, as shown in FIG. 9, a toner image of black on the sheet P becomes an inclined toner image 117 as indicated by a solid line with respect to a proper position 116 indicated by a chain line.

In order to adjust the inclination, the arithmetic unit 103 sets the inclination amounts of the tilt mirrors 112Y, 112M, 112C and 112K according to the inclination amount. As shown in FIG. 10, the mirror driver 112 drives tilt motors 312Y, 312M, 312C and 312K respectively when necessary (A202), and adjusts the inclination of the respective tilt mirrors 112Y, 112M, 112C and 112K in an arrow s direction. Scanning lines 114Y, 114M, 114C and 114K requiring adjustment are shifted in an arrow t direction on the photoconductive drums 12Y, 12M, 12C and 12K and the image inclination is adjusted.

(b) Adjustment of Image Writing Start Timing

For example, as shown in FIG. 11, in the case that an interval T1 between the patterns 50C, 51C of cyan (C) and the pattern 50K, 51K of black (K) is shifted from an interval T2 between other patterns (Yes at A203).

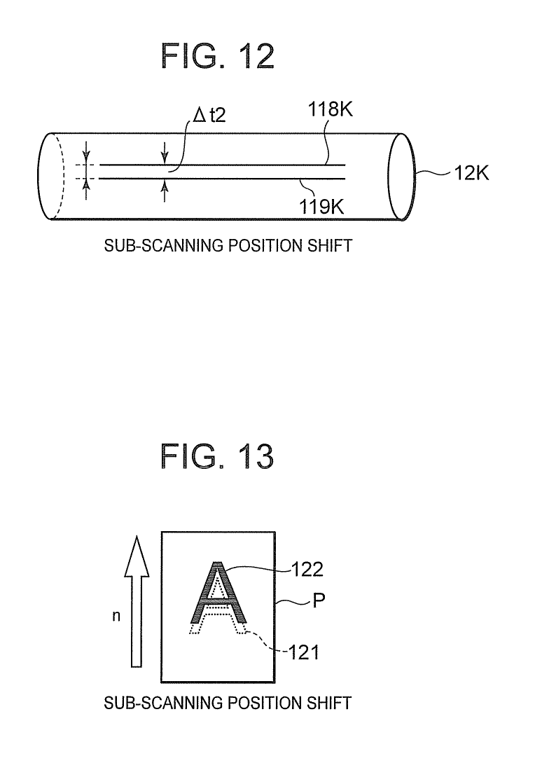

As shown in FIG. 12, the arithmetic unit 103 determines that a position 118K of the pattern 50K, 51K of black (K) is shifted with respect to an original position 119K in the sub-scanning direction by Δt2 as the difference between the interval T1 and the interval T2. When image formation is performed without adjustment, as shown in FIG. 13, a black toner image on the sheet P becomes a toner image 122 indicated by a solid line shifted in the sub-scanning direction with respect to a proper position 121 indicated by a chain line.

The arithmetic unit 103 sets, as an adjustment value, a difference in output timing of image data corresponding to Δt2. The laser control unit 110 shifts the output timing of the black laser oscillator 111K in the sub-scanning direction according to Δt2 (A204). The output timings of the laser oscillators 111Y, 111M, 111C and 111K requiring adjustment are shifted.

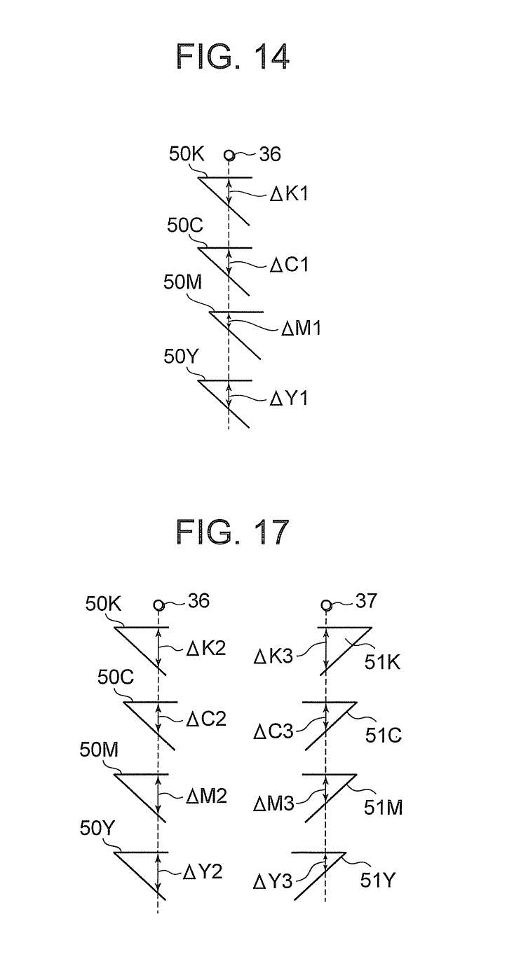

For example, as shown in FIG. 14, in the case that detection lengths ΔK1, ΔC1, ΔM1 and ΔY1 of the respective front side patterns 50K, 50C, 50M and 50Y are shifted (Yes at A206).

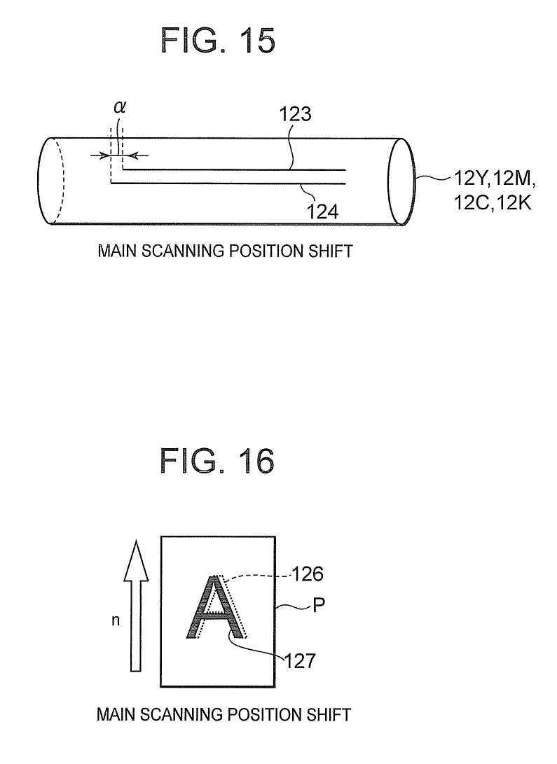

As shown in FIG. 15, the arithmetic unit 103 determines that each color component 123 shifts in the main scanning direction by α with respect to an original position 124. When image formation is performed without adjustment, as shown in FIG. 16, a toner image of each color formed on the sheet P becomes a toner image 127 indicated by a solid line shifted in the main scanning direction with respect to a proper position 126 indicated by a chain line. The amount of the image position shift in the main scanning direction is determined from the respective differences of the detection lengths ΔK1, ΔC1, ΔM1 and ΔY1 of the front side patterns 50K, 50C, 50M and 50Y.

In order to adjust the shift in the main scanning direction, the arithmetic unit 103 sets, as an adjustment value, a shift amount in the main scanning direction of image data corresponding to the detection lengths ΔK1, ΔC1, ΔM1 and ΔY1. The adjustment value is set so that ΔK1=ΔC1=ΔM1=ΔY1 is established. The laser control unit 110 shifts the output start timings of the laser oscillators 111Y, 111M, 111C and 111K in the main scanning direction.

(c) Magnification Error Adjustment

For example, as shown in FIG. 17, in the case that detection lengths ΔK2, ΔC2, ΔM2 and ΔY2 of the front side patterns 50K, 50C, 50M and 50Y of the respective color components are respectively shifted from detection lengths ΔK3, ΔC3, ΔM3 and ΔY3 of the rear side patterns 51K, 51C, 51M and 51Y (Yes at A208).

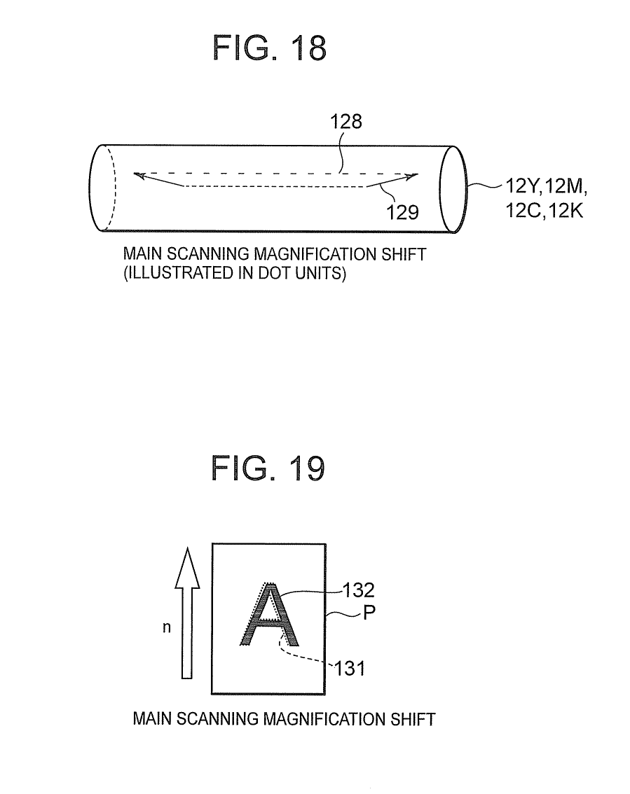

As shown in FIG. 18, the arithmetic unit 103 determines that a dot interval of each color component 128 is different from a dot interval of an original pattern 129 and a magnification shift occurs in the main scanning direction. When image formation is performed without adjustment, as shown in FIG. 19, a toner image formed on the sheet P becomes a toner image 132 indicated by a solid line, which is subjected to the magnification shift in the main scanning direction with respect to a proper image 131 indicated by a chain line. The amount of the image magnification shift in the main scanning direction is determined from the value of addition of each of the front side detection lengths ΔK2, ΔC2, ΔM2 and ΔY2 of the respective color components and each of the rear side detection lengths ΔK3, ΔC3, ΔM3 and ΔY3. When (ΔK2+ΔK3)=(ΔC2+ΔC3)=(ΔM2+ΔM3)=(ΔY2+ΔY3) is established, it is determined that the image magnification for each color component in the main scanning direction is constant.

In order to adjust the magnification shift in the main scanning direction, the arithmetic unit 103 sets the frequency of the image clock as the adjustment value. The laser control unit 110 adjusts the clock frequency of the laser oscillators 111Y, 111M, 111C and 111K respectively (A210), and ends the image registration adjustment. In (I)-(a), (I)-(b) and (I)-(c), as the example in which the shift with respect to the design reference value is adjusted, the description is made on the case where the adjustment is made on all the four colors. As another method, one specified color (for example, black (K)) may be made the reference. The shift amounts of the other colors (for example, yellow (Y), magenta (M), cyan (C)) with respect to the value of black (K) are adjusted and the shift may be resolved only by adjusting the thee colors.

(II) Image Density Adjustment

In the color image forming apparatus, at the time of toner image formation, the charging device applies an electric charge to the photoreceptor and charges the photoreceptor to, for example, a surface potential V₀. When exposure light is irradiated to the photoreceptor according to image information, an electrostatic latent image of residual potential Ver is formed on the photoreceptor. The developing device supplies toner to the portion of the residual potential Ver of the photoreceptor and develops the electrostatic latent image on the photoreceptor. When a development bias Vb is applied to the developing device, the toner adhesion amount of the photoreceptor is changed according to the value of |Vb−Ver|, and the image density is changed (|Vb−ver| is called a development contrast Vc). In the image density adjustment, the development contrast Vc is adjusted, and further, the exposure light amount is adjusted.

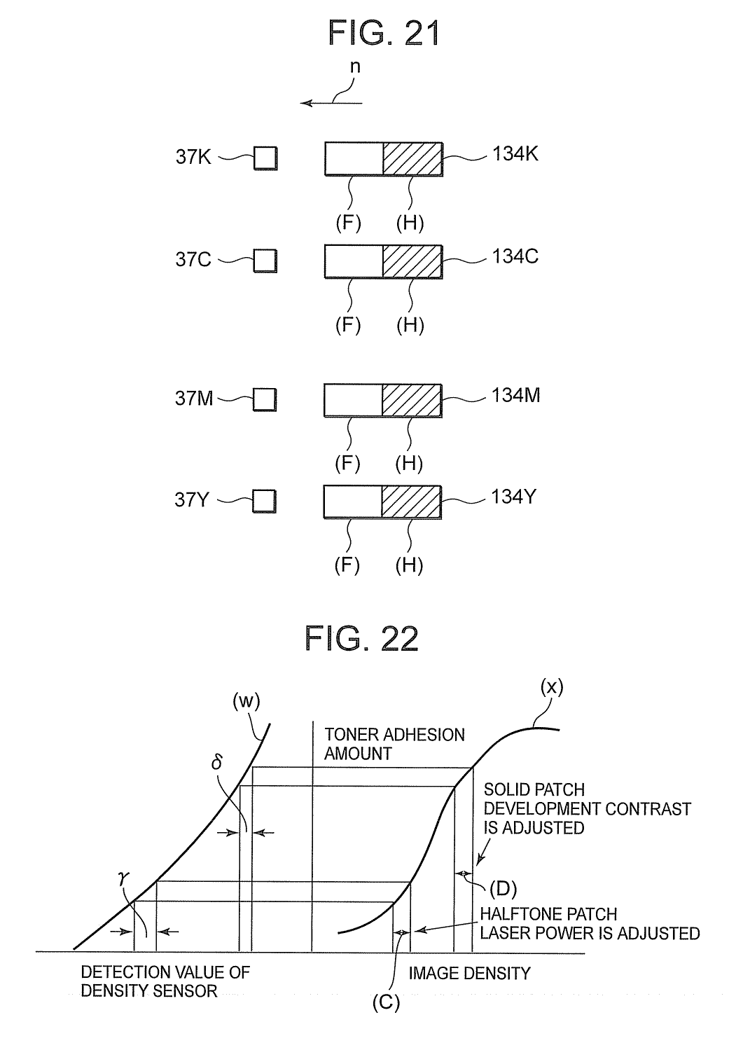

When the image density adjustment is started, as shown in FIG. 21, the image forming stations 11Y, 11M, 11C and 11K print patches 134Y, 134M, 134C and 134K of four colors of Y, M, C and K in the image formation area (A) of the transfer belt 10 (A300). The image forming stations 11Y, 11M, 11C and 11K arrange the patches 134Y, 134M, 134C and 134K on the straight line of the transfer belt 10 in the main scanning direction for the respective color components.

Each of the four color patches 134Y, 134M, 134C and 134K include a filled patch (F) and a halftone patch (H) composed of dots of a specified pattern. The four color patches 134Y, 134M, 134C and 134K each having the filled patch (F) and the halftone patch (H) are made one set, and the image forming stations 11Y, 11M, 11C and 11K print, for example, one set on the transfer belt 10.

The toner adhesion amount sensors 37Y, 37M, 37C and 37K respectively detect, for the respective color components, the toner adhesion amounts of the filled patches (F) and the halftone patches (H) of the four color patches 134Y, 134M, 134C and 134K (A301). The toner adhesion amount sensors 37Y, 37M, 37C and 37K detect the toner adhesion amounts at, for example, 10 points of each of the filled patch (F) and the halftone patch (H) for the respective color components.

The arithmetic unit 103 calculates the average of the detection values of the toner adhesion amount sensors 37Y, 37M, 37C and 37K and determines the toner adhesion amount for each color component (A302). The arithmetic unit 103 calculates a difference between a target range of image density for each color component stored in the memory 102 and the determined toner adhesion amount for each color component (A303). FIG. 22 shows a relation between the detection value of the toner adhesion amount sensors 37Y, 37M, 37C and 37K, the toner adhesion amount on the transfer belt 10, and the image density. A solid line (w) indicates the detection value of the toner adhesion amount sensors 37Y, 37M, 37C and 37K, and a solid line (x) indicates the toner adhesion amount on the transfer belt 10. With reference to FIG. 22, the range of the detection value of the toner adhesion amount sensors 37Y, 37M, 37C and 37K is determined according to the target range of the image density. For example, when the target range of the image density of the halftone patch (H) is (C), the range of the detection value of the toner adhesion amount sensors 37Y, 37M, 37C and 37K is determined to be (γ). When the target range of the image density of the filled patch (F) is (D), the range of the detection value of the toner adhesion amount sensors 37Y, 37M, 37C and 37K is determined to be (δ).

The CPU 101 determines from the calculation result whether the difference of the image density for each color component is in the specified range (A304). When the difference of the image density for each color component is in the specified range (Yes at A304), the density adjustment is ended.

When the difference of the image density for each color component exceeds the specified range (No at A304), advance is made to A307. At A307, the density condition is adjusted for each color component. As the adjustment of the density condition, the print control unit 120 adjusts the development contrast Vc so that the image density of the filled patch (F) falls within the target range (δ). Further, the laser driver 111 adjusts the laser light amount Lp of the laser exposure device 17 so that the image density of the halftone patch (H) falls within the target range (γ). The image density is adjusted at the two points of the filled patch (F) and the halftone patch (H).

The image forming stations 11Y, 11M, 11C and 11K print the patches 134Y, 134M, 134C and 134K of the four colors of Y, M, C and K in the image formation area (A) of the transfer belt 10 under the density condition adjusted at A307 (A308) and by using patch data for density adjustment. A301 to A304 are executed, and when the difference of the image density for each color component after the density adjustment is in the specified range (Yes at A304), the density adjustment is ended. When the difference of the image density for each color component exceeds the specified range (No at A304), A307, A308 and A301 to A304 are repeated. The adjustment of the development contrast Vc and the laser light amount Lp is repeated a specified number of times at maximum so that the outputs of the toner adhesion amount sensors 37Y, 37M, 37C and 37K fall within the target ranges (δ) and (γ).

At the time of the image density adjustment, the variation in detection accuracy of the four toner adhesion amount sensors 37Y, 37M, 37C and 37K detecting the toner adhesion amounts of the four color patches 134Y, 134M, 134C and 134K for each color component is corrected. At the time of correction of the variation in the detection accuracy, one of the image forming stations 11 is used, and four lines of marks for correction having the same color and the same density are formed on the transfer belt 10. The four toner adhesion amount sensors 37Y, 37M, 37C and 37K respectively detect the same marks for correction on the transfer belt 10. The detection values of the four toner adhesion amount sensors 37Y, 37M, 37C and 37K are respectively compared with, for example, a reference value or an average value, a correction is performed, and detection accuracy is uniformed. The correction of the variation in the detection accuracy of the four toner adhesion amount sensors 37Y, 37M, 37C and 37K is adjusted, for example, before factory shipment of the color copying machine 1.

When the image registration adjustment is completed in accordance with the flowchart of FIG. 5 and the image density adjustment is completed in accordance with the flowchart of FIG. 20, the belt cleaner 19 removes the patterns 50 and 51 and the patches 134Y, 134M, 134C and 134K on the transfer belt 10. The color copying machine 1 completes the image adjustment, and after the warming-up is completed, image printing is started according to image data.

During image printing, the image registration adjustment and the image density adjustment are periodically performed at, for example, intervals of 30 minutes or according to the number of prints. For example, even when image printing is performed in the image formation area (A) of the transfer belt 10, the wedge-shaped patterns 50 and 51 for image registration adjustment are printed in the non-image formation areas (B) at intervals of 30 minutes. In parallel to the print process of the image in the image formation area (A), the first and the second registration sensors 27 and 28 measure the patterns 50 and 51 in the non-image formation areas (B), and (I) the image registration adjustment is performed. The image registration is performed during the image print process.

The image density adjustment is performed in the state where the image print process in the image formation area (A) is on standby. The four color patches 134Y, 134M, 134C and 134K are arranged and are printed for the respective color components in the main scanning direction in the image formation area (A) of the transfer belt 10. Each of the four toner adhesion amount sensors 37Y, 37M, 37C and 37K detect the toner adhesion amounts of the respective four color patches 134Y, 134M, 134C and 134K arranged in the main scanning direction of the transfer belt 10 at the same timing, and (II) the image density adjustment is performed. After the detection of the four color patches 134Y, 134M, 134C and 134K, the belt cleaner 19 removes the patches 134Y, 134M, 134C and 134K, and the waiting image print process is started.

According to the first embodiment, the non-image formation area (B) of the transfer belt 10 is used and the image registration is performed. The image registration adjustment can be performed even in the image print process. A process time for the image registration is not required in addition to the image print time. The four color patches 134Y, 134M, 134C and 134K are printed in the main scanning direction of the transfer belt 10, and are detected at the same timing by using the respective four toner adhesion amount sensors 37Y, 37M, 37C and 37K. The four color patches 134Y, 134M, 134C and 134K for density adjustment can be detected in a short time. The time of warming-up can be shortened. After the warming-up, the standby time for the image print process at the time of density adjustment of image can be shortened.

### Second Embodiment

A second embodiment will be described. The second embodiment is such that in the first embodiment, an image position shift in a center area of the transfer belt is further measured and image registration is performed. In the second embodiment, the same component as the component described in the first embodiment is denoted by the same reference numeral and its detailed description is omitted.

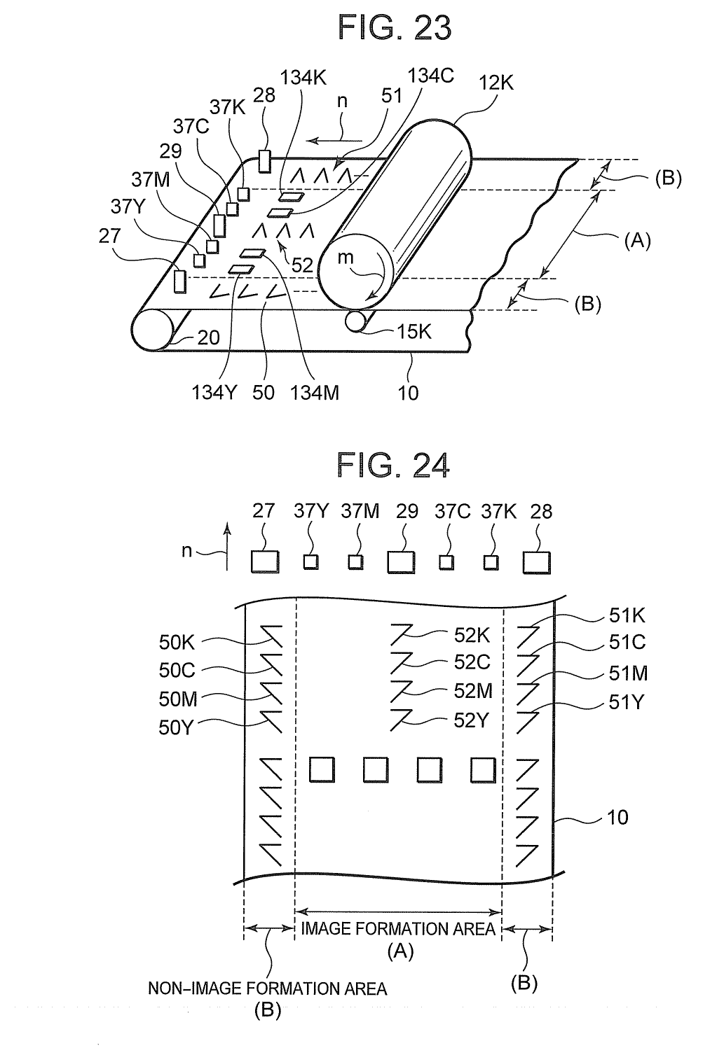

In the second embodiment, as shown in FIG. 23 and FIG. 24, a third registration sensor 29 is provided at substantially the center position between a first and a second registration sensors 27 and 28. For example, at the time of image registration adjustment during warming-up, image forming stations 11Y, 11M, 11C and 11K print 8 sets of front side patterns 50Y, 50M, 50C and 50K in a front side non-image formation area (B) of a transfer belt 10, and print 8 sets of rear side patterns 51Y, 51M, 51C and 51K in a rear side non-image formation area (B) of the transfer belt 10. At the same time, the image forming stations 11Y, 11M, 11C and 11K print 8 sets of center patterns 52Y, 52M, 52C and 52K in the center area of the transfer belt 10. The first to the third registration sensors 27 to 29 measure the 8 sets of each of the patterns 50 and 51 in the non-image formation area (B) of the transfer belt 10 and the pattern 52 in the center area, and the arithmetic unit 103 calculates the average value of each of the patterns 50 to 52.

In image registration adjustment, (c) magnification error adjustment is influenced by, for example, the characteristic of an optical system of a laser exposure device 17. Since the characteristic of the optical system of the laser exposure device 17 is not uniform in the main scanning direction, in the second embodiment, the measurement places of the patterns on the transfer belt 10 are increased, and a more accurate magnification shift is measured.

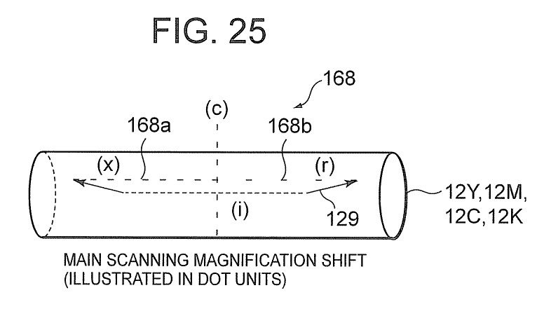

The arithmetic unit 103 calculates a shift with respect to a dot interval of an original pattern 129 from measurement values of the first to the third registration sensors 27 to 29. As shown in FIG. 25, the arithmetic unit 103 calculates that for example, the shift of the dot interval of a color component 168a from the front side to the center area (C) is x times the dot interval of the original pattern 129, and the shift of the dot interval of the color component 168b from the center area (C) to the rear side is y times the dot interval of the original pattern 129.

When the magnification error adjustment is performed by detecting the patterns at two places of the front side and the rear side non-image formation areas (B) of the transfer belt 10, at the front side, the adjustment value of the clock frequency is weighted according to the magnification shift of x times, and at the rear side, the adjustment value of the clock frequency is weighted according to the magnification shift of y times.

The print of the center patterns 52Y, 52M, 52C and 52K in the center area of the transfer belt 10 and the measurement of the patterns by the third registration sensor 29, which are performed for weighting the adjustment value of the clock frequency, are performed during, for example, warming-up of the color copying machine 1 or before the change to a power saving mode. At the other time, similarly to the first embodiment, the first and the second registration sensors 27 28 measure the patterns 50 and 51 formed in the non-image formation areas (B) of the transfer belt 10. Similarly to the first embodiment, (I) the image registration adjustment is performed. Further, similarly to the first embodiment, (II) the image density adjustment is performed.

According to the second embodiment, similarly to the first embodiment, the image registration adjustment can be performed even during the image print process, and the process time for the image registration is not required in addition to the image print time. Besides, when the image print process is not performed, the center area of the transfer belt 10 is used, and the front side magnification shift and the rear side magnification shift are obtained. At the time of magnification error adjustment, the adjustment values of the clock frequencies at the front side and the rear side are weighted, and the accuracy of the magnification error adjustment is increased. Similarly to the first embodiment, the detection time of the four color patches 134Y, 134M, 134C and 134K for density adjustment is shortened, the warming-up time is shortened, and the standby time of the image print process which is on standby at the time of the density adjustment is shortened.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. An image forming apparatus comprising:
a running member including an image formation area;
a plurality of image forming sections to form a density adjustment pattern respectively on a straight line perpendicular to a running direction of the running member at a time of density adjustment;
a plurality of density detection sections to detect the density adjustment patterns on the straight line respectively and simultaneously; and
a density correction section to correct image densities of the plurality of image forming sections respectively based on detection results of the density adjustment patterns obtained by the plurality of density detection sections.

2. The apparatus of claim 1, wherein the plurality of density detection sections correct a variation in detection characteristics between the density detection sections respectively.

3. The apparatus of claim 2, wherein a correction of the respective variation of the plurality of density detection sections, sets a reference value, compares a respective detection result of the plurality of density detection sections with the reference value, and corrects the correction.

4. The apparatus of claim 3, wherein the reference value is an average value of the respective detection result of the plurality of density detection sections.

5. The apparatus of claim 1, wherein the running member has non-image formation areas on both sides of the image formation area in a direction parallel to the running direction, and the plurality of image forming sections form shift adjustment patterns in the non-image formation areas, and
the image forming apparatus further comprises:
a shift detection section to detect the shift adjustment patterns formed in the non-image formation areas; and
a shift correction section to correct an image shift between the plurality of image forming sections based on a detection result of the shift adjustment patterns obtained by the shift detection section.

6. The apparatus of claim 5, wherein the plurality of image forming sections form the shift adjustment patterns in the non-image formation areas during image formation in the image formation area.

7. The apparatus of claim 5, wherein the plurality of image forming sections form a second shift adjustment pattern in the image formation area of the running member simultaneously with formation of the shift adjustment patterns in the non-image formation areas,
the image forming apparatus further comprises a second shift detection section to detect the second shift adjustment pattern formed in the image formation area, and
the shift correction section corrects the image shift between each of the plurality of image forming sections based on the detection results of the shift adjustment pattern obtained by the shift detection section and a detection results of the second shift adjustment pattern obtained by the second shift detection section.

8. The apparatus of claim 7, wherein the shift correction section to set an adjustment values of the shift detection sections from the detection results of the shift detection sections and the second shift detection section, and to adjust the detection results of the shift adjustment patterns obtained by the shift detection sections.

9. The apparatus of claim 1, wherein the plurality of image forming sections are arranged along the running member, includes a plurality of image carriers to carry toner images different in color respectively, and a plurality of transfer sections to transfer the toner images different in color to the running member respectively, and
at a time of image formation, the toner images different in color on the plurality of image carriers are superimposed in the image formation area of the running member.

10. An image forming apparatus comprising:
a running member including an image formation area and non-image formation areas on both sides of the image formation area in a direction parallel to a running direction;
a plurality of image forming sections to form shift adjustment patterns in the non-image formation areas;
a plurality of shift detection sections to detect the shift adjustment patterns formed on the running member; and
a shift correction section to correct an image shift between the plurality of image forming sections based on detection results of the shift adjustment patterns obtained by the plurality of shift detection sections.

11. The apparatus of claim 10, wherein the plurality of image forming sections form the shift adjustment patterns in the non-image formation areas during image formation in the image formation area.

12. The apparatus of claim 10, wherein the plurality of image forming sections form a second shift adjustment pattern in the image formation area of the running member simultaneously with formation of the shift adjustment patterns in the non-image formation areas,
the image forming apparatus further comprises a second shift detection section to detect the second shift adjustment pattern formed in the image formation area, and
the shift correction section corrects the image shift between each of the plurality of image forming sections based on the detection results of the shift adjustment pattern obtained by the shift detection section and a detection results of the second shift adjustment pattern obtained by the second shift detection section.

13. The apparatus of claim 12, wherein the shift correction section to set an adjustment values of the shift detection sections from the detection results of the shift detection sections and the second shift detection section, and to adjust the detection results of the shift adjustment patterns obtained by the shift detection sections.

14. The apparatus of claim 10, wherein the plurality of image forming sections are arranged along the running member, includes a plurality of image carriers to carry toner images different in color respectively, and a plurality of transfer sections to transfer the toner images different in color to the running member respectively, and
at a time of image formation, the toner images different in color on the plurality of image carriers are superimposed in the image formation area of the running member.

15. An image forming method comprising:
forming a plurality of density adjustment patterns on a straight line perpendicular to a running direction of a running member by a plurality of image forming sections;
detecting the plurality of density adjustment patterns on the straight line respectively and simultaneously; and
correcting image densities of the plurality of image forming sections respectively based on detection results of the plurality of density adjustment patterns.

16. The method of claim 15, further comprising correcting a variation in detection characteristics between a plurality of density detection sections which respectively and simultaneously detect the plurality of density adjustment patterns.

17. The method of claim 15, further comprising:
forming shift adjustment patterns in non-image formation areas of the running member by the plurality of image forming sections;
detecting the shift adjustment patterns formed in the non-image formation areas; and
correcting an image shift between the plurality of image forming sections based on detection results of the shift adjustment patterns.

18. An image forming method comprising:
forming shift adjustment patterns in non-image formation areas of a running member by a plurality of image forming sections;
detecting the shift adjustment patterns formed in the non-image formation areas; and
correcting an image shift between the plurality of image forming sections based on detection results of the shift adjustment patterns.

19. The method of claim 18, wherein the shift adjustment patterns in the non-image formation areas forming while the plurality of image forming sections form images in an image formation area of the running member.

20. The method of claim 18, further comprising:
forming a second shift adjustment pattern in an image formation area of the running member by the plurality of image forming sections simultaneously with the forming the shift adjustment patterns in the non-image formation areas,
detecting the shift adjustment patterns formed in the non-image formation area and the second shift adjustment pattern formed in the image formation area, and
correcting the image shift between the plurality of image forming sections based on the detection results of the shift adjustment patterns and a detection result of the second shift adjustment pattern.
